(19) United States
(12) Patent Application Publication
(10) Pub. No.: US 2010/0092575 A1
(43) Pub. Date: Apr. 15, 2010

(54) Method of making treatment materials and using same to treat algae and/or pests

(76) Inventor: David T. McFadden, Pacific Grove, CA (US)

Correspondence Address: Gregor Neff, Esq., 14th floor, 489 5th Avenue, New york, NY, 10017, US

(21) Appl. No.: 12/653,254

(22) Filed: Dec. 11, 2009

Related U.S. Application Data
(62) Division of application No. 11/244,215, filed on Oct. 5, 2005.
(60) Provisional application No. 60/616,505, filed on Oct. 5, 2004.

(51) Int. Cl. A01N 59/00

(52) U.S. Cl. 424/616

(57) ABSTRACT

The present invention is directed to a composition for treating algae and pests in water or soil. The compositions of the present invention include an oxidizing agent, a thickener, and water. It is preferable to further include a stabilizer for the oxidizing agent. The components of the composition are preferably biocompatible with the water or soil, and more preferably biodegradable.

### CROSS REFERENCE TO RELATED APPLICATIONS

This application claims priority to U.S. Provisional Application Ser. No. 60/616,505 filed on Oct. 5, 2004, which is incorporated herein by reference in its entirety.

### TECHNICAL FIELD

The present invention relates generally to chemical compositions used to treat algae and pests in water or soil, methods for making the compositions, and methods for using the compositions.

### BACKGROUND OF THE INVENTION

Large bodies of water and water features (such as ponds, fountains, waterfalls, pools, lakes, and reservoirs) typically suffer from algal growth, such as string algae. Algal growth is believed to be promoted by a variety of conditions, such as sunlight, warm water, decomposition of organic matter, and the effluent from biological wastes. Without wanting to be limited to any one theory, it is believed that oxygen depletion yields an anaerobic environment that may (i) provide a less conducive environment for flora and fauna that depend on oxygen, (ii) promote growth of harmful pathogens and fungi, and (iii) help create noxious odors. These conditions can promote further algae growth, thereby depleting aerobic species and impeding mechanical and hydraulic processes of the water feature (e.g., by clogging).

Furthermore, the edges and sides of large bodies of water and water features are typically more susceptible to algae growth due to the shallower depth. Since more sunlight can penetrate to the bottom surface and create warmer temperatures, algae are more prone to anchor and propagate in such locations. As a result, algae tend to grow on the sides, edges and ornamental and functional portions of water features that typically reside at shallow depths. These portions are believed to be significantly more depleted of oxygen due to algae growth and respiration in comparison to deeper portions of the water body. The anaerobic conditions at the sides and edges also promote reducing sulfurous conditions, which increase the growth of slime forming bacteria and noxious odors.

It is known in the art to use a variety of chemical compositions and techniques for the control and eradication of algae in water features. These include the application of beneficial bacteria, enzymes, synthetic organic polymers, synthetic organic small molecules, and copper sulfate to the entire water body. The aforementioned materials are typically used by direct addition to said water body by in-line flow injection or by dumping volumes of the material into the water body.

However, these materials and methods of use have produced varying results. For example, copper sulfate can be detrimental to the environment, and bacteria and enzymes can be difficult to control. Furthermore, synthetic polymers and molecules may be detrimental to the health of the ecosystem.

It is, therefore, an object of the present invention to provide an effective composition for oxygenation of water and soil.

### SUMMARY OF THE INVENTION

The present invention is directed to compositions, processes for making the compositions, and methods of using the compositions for treating algae and pests. The composition includes an oxidizing agent, a stabilizer, a thickener, and water. The composition is preferably biocompatible with the ecosystem to which it is applied. The oxidizing agent is typically present at a concentration range of from about 0.01% to about 50% by weight; the stabilizer is typically present at a concentration range from about 0.1% to about 40% by weight; the thickener is typically present at a concentration range from about 0.001% to about 25% by weight; and the balance is water.

In one embodiment, the composition includes peroxide as the oxidizing agent, an organic acid as the stabilizer, and a saponin as the thickener. In another embodiment the composition includes hydrogen peroxide as the oxidizing agent, citric acid as the stabilizer, and yucca extract as the thickener. In still another embodiment, the composition does not require the stabilizer.

The present invention also includes a process of making a composition for treating algae or pests. The process includes a first step of adding a stabilizer to an aqueous solution comprising an oxidizing agent, and a second a step of adding a thickener to the mixture of the first step. Other embodiments contemplate forming a two-part solution that is later combined to make the composition. In one embodiment, the process includes mixing a first portion of the composition by adding a stabilizer to an aqueous solution comprising an oxidizing agent, mixing a second portion of the composition by adding a thickener to water, and mixing the first portion and the second portion together before application of the composition. In another embodiment, the process includes presenting a first portion of the composition including an aqueous solution of an oxidizing agent, mixing a second portion of the composition by adding a thickener and a stabilizer to water, and mixing the first portion and the second portion together before application of the composition. In all of these embodiments for the process, the concentration ranges and the particular identifications of the components described above for the composition also apply to the process.

The present invention is also directed to the products obtained from the different process.

The present invention is also directed to a method for treating algae or pests including applying to water of a water feature or large body of water a composition comprising, an oxidizing agent, a thickener, and water. The composition can further include a stabilizer. In one embodiment the method is directed to selective application to portions of the water surface affected by algae. In all of these embodiments for the process, the concentration ranges and the particular identifications of the components described above for the composition also apply to the process.

In another embodiment, the present invention present invention is directed to a method for treating algae or pests including applying soil a composition comprising, an oxidizing agent, a thickener, and water. The composition can further include a stabilizer. In one embodiment the method is directed to selective application to portions of the water surface affected by algae. In all of these embodiments for the process, the concentration ranges and the particular identifications of the components described above for the composition also apply to the process.

### DETAILED DESCRIPTION OF THE INVENTION

The present invention is directed to a composition for treating algae and pest in water or soil. The compositions of the present invention include an oxidizing agent, a thickener, and water. It is preferable to further include a stabilizer for the oxidizing agent. The components of the composition are preferably biocompatible with the water or soil, and more preferably biodegradable.

Without wanting to be limited to any one theory, it is believed that the compositions of the present application (and the methods of using these compositions) help to inhibit, kill or remove algae and pests in water or soil.

All percentages, ratios and proportions herein are by weight of the composition, unless otherwise specified. All temperatures are in degrees Celsius (° C.) unless otherwise specified. All documents cited are incorporated herein by reference in their entireties. Citation of any reference is not an admission regarding any determination as to its availability as prior art to the claimed invention.

As used herein, the term “water features” means any artificial or natural structure associated with water (such as ponds, fountains, pipes, waterfalls, pools, lakes, and reservoirs) and the water in the structures.

As used herein, the term “large body of water” means a body of water have a surface area equal to or greater than about 4,000 m² (1 acre) of water.

As used herein, the term “biocompatible” means the compatibility with an ecosystem by not being toxic or injurious. Accordingly, it can be a relative term. The term biocompatible includes the definition provided herein for the term biodegradable.

As used here, the term “biodegradable” means capable of being broken down into harmless components.

As used herein, the term “about” means plus or minus 10% the referenced value.

In one embodiment, the compositions of the present invention can be provided in a neat or concentrated form (e.g., before dilution with water). In this embodiment, the concentrations of components are as follows:

(1) the oxidizing agent: from about 0.01% to about 50%, preferably from about 3% to about 15% by weight of the neat composition, and more preferable from about 5% to about 10% by weight of the neat composition;

(2) stabilizer (optional): from about 0.1% to about 40% by weight of the neat composition, preferably from about 1% to about 20% by weight of the neat composition, and more preferable from about 3% to about 15% by weight of the neat composition;

(3) thickener: from about 0.001% to about 25% by weight of the neat composition, and preferably from about 0.1% to about 16% by weight of the neat composition; and

(4) water: remainder.

In another embodiment, the neat compositions can be diluted or a diluted composition can be made for use on or in the target water or soil. In this embodiment, the concentrations of components are as follows:

(1) oxidizing agent: from about 0.01% to about 15% by weight of the diluted composition, and preferably from about 0.05% to about 10% by weight of the diluted composition;

(2) stabilizer (optional): from about 1% to about 15% by weight of the diluted composition, and preferably from about 3% to about 10% by weight of the diluted composition;

(3) thickener: from about 0.001% to about 5% by weight of the diluted composition, and preferably from about 0.005% to about 4% by weight of the diluted composition; and

(4) water: remainder.

Accordingly, after mixing and dispersion, the concentration of the oxidizing agent can be equal to or less than 1 wt % in the target water. Higher concentrations of the oxidizing agent are allowable in soil.

### A. Oxidizing Agent

The compositions of the present invention include an oxidizing agent. Fast acting oxidizing agents are preferred to allow selective application. The oxidizing agent is preferably biocompatible with the water or soil, and more preferably biodegradable in the water or soil or decomposes to innocuous byproducts. Without wanting to be limited by any one theory, it is believed that the oxidizing activity of the oxidizing agent effectively removes or kills algae and pests in water or soil.

Examples of suitable oxidizing agents include, but are not limited to, the following: peroxides, such as H₂O₂, Na₂O₂, CaO₂, and BaO₂; oxygen (O₂); ozone (O₃); bromine (Br₂); potassium permanganate (KMnO₄); potassium chlorate (KClO₃); nitric acid (HNO₃); percarbonates, such as sodium percarbonate; and combinations thereof. Lower concentrations can be used for less biocompatible compounds. Potassium permanganate and peroxides are preferred because of their biologically inert byproducts and high biocompatibility.

Hydrogen peroxide is preferred, because of its cost, ease of handling, oxidizing potential, low toxicity and desirable non-toxic decomposition byproducts. For example, hydrogen peroxide has the unique advantage of decomposing to harmless byproducts oxygen and water, as illustrated in Equations 1-3 below.
Equation 1: Generation of oxidizing hydroxyl radicals

2H₂O₂ 4HO
Equation 2: Decomposition of hydroxyl radicals after oxidation of matter

4HO O₂+2H₂O
Equation 3: Net equation or the sum of equations 1 and 2

2H₂O₂ O₂+2H₂O

As is known in the art, hydrogen peroxide may also be obtained as the hydrolysis product of solid sodium percarbonate (Na₂CO₃ 3H₂O₂), which results in an alkaline solution. Generation of hydrogen peroxide with sodium percarbonate may be desirable in those water systems with low pH values. Other solid inorganic hydrogen peroxide sources include sodium perborate, calcium peroxide, and magnesium peroxide. However, aqueous acidic hydrogen peroxide solutions are preferred for ease of application and utility.

After application of the composition to the water or soil, the actual concentration of the oxidizing agent in the body of water or soil is very low. When portions of soil or a body of water are treated with the composition, higher local concentrations of the oxidizing agent and resulting byproducts can be controlled for short periods. For example, in most cases after treatment of the outer edges of a water feature with a composition containing hydrogen peroxide, the effective residual hydrogen peroxide concentration in the entire water body is well below 0.1% by weight of the water body. This is especially advantageous, since hydrogen peroxide is exempt from EPA regulation when the residual concentration is equal to or less than 1% by weight of the target water.

### B. Stabilizer

Although not required, the compositions of the present invention preferably include a stabilizer to stabilize the oxidizing agent. The stabilizer preferably stabilizes at least a portion of the oxidizing agent for at least 30 minutes after application, and more preferably at least 4 hours after application. The stabilizer is preferably biocompatible with flora and fauna at the specified levels, and is more preferably non-persistent. The stabilizer can be any compound known to the skilled artisan that helps to prevent premature activation of the oxidizing agent. Accordingly, the stabilizer is chosen according to oxidizing agent.

For example, when the oxidizing agent is hydrogen peroxide, the stabilizer can help to provide a substantially acidic medium (e.g., pH<<7) to prevent premature decomposition of the hydrogen peroxide, which decomposes at a significantly increased rate at pH values greater than about 6. Some stabilizers can also help to lower pH to a level that is optimal for healthy water ecology, as well as aid in precipitating metal ions.

Suitable examples of useful stabilizers include organic acids, inorganic acids, tartaric acid, sodium salicylate, urea, and combinations thereof. Suitable examples of additional stabilizers can be found in U.S. Pat. No. 5,523,012 to Winterton et al., which is incorporated herein by reference it its entirety. Organic acids are preferred, because some inorganic acids may add ionic species that may not be desirable or biocompatible with the ecology of the target water or soil. Furthermore, it is preferred to minimize the concentration of transition metal ions (such as Cu²⁺, Fe²⁺, Fe³⁺, Ti²⁺, etc), which can activate the oxidizing agent. As is well known in the art, the amount and choice of specific organic acids and inorganic acids are based on pKa values, pH buffering capacity, and biocompatibility. For example, acidic solutions are preferred in those water features that predominantly display alkaline pH.

Suitable organic acids include those having carboxyl radicals, generally classified in the art as monobasic acids (RCOOH), dibasic acids (R(COOH)₂), tribasic acids (R(COOH)₃), tetrabasic acids R(COOH)₄), and pentabasic acids (R(COOH)₅), wherein R is a carbon containing group. Examples of suitable organic acids having one or more carboxyl radicals include, but are not limited to, the following: acetic acid, acrylic acid, acetylene acid, oxalic acid, phtalic acid, citric, malic acid, succinic acid, uric acid, tartaric acid, and combinations thereof. Examples of other useful organic acids include, but are not limited to, ascorbic acid, urea, and combinations thereof.

Citric acid (C₃H₄(OH)(COOH)₃.—H₂O) is preferred when the oxidizing agent is hydrogen peroxide. Citric acid is preferred due to its low comparative cost, non-toxic nature, and buffering capacity. Citric acid is a triprotic acid that provides three equivalents of protons. The three pKa values are: 3.06, 4.74, and 5.40. Citric acid can be added to the composition to provide an acidic medium (pH<<7) so that the hydrogen peroxide does not prematurely decompose prior to application, since hydrogen peroxide decomposition significantly increases at pH values greater than 6. Furthermore, it is believed that citric acid also provides the additional benefit of metal ion removal by chelation, since transition metal ions can increase the decomposition of hydrogen peroxide.

### C. Thickener

The compositions of the present invention include a thickener, which is also referred to herein as a spreading agent. Although any thickener known in the art may be used in the compositions of the present invention, the thickener preferably has a sticky quality that helps the composition to adhere to a fluid or solid surface. It is believed that the thickener aids in the adhesion of the mixture to algae on the water surface, soil, foliage or other structures of the water feature or water body. The thickener also allows selective treatment of particular areas of the water or soil without excessive dispersion into other areas where the mixture is not needed. The thickener is preferably biocompatible with the water or soil, and more preferably biodegradable in the water or soil. Accordingly, it is preferred to utilize naturally available thickeners.

Naturally occurring thickeners are typically starch-like materials. Suitable natural thickeners for use in the compositions of the present invention include saponins, such as Yucca extract (also known as Yucca schidigera), soap bark tree extract (Quillaja saponoria), and combinations thereof. Yucca extract is particularly preferred as the thickener.

Surprising results have been obtained using Yucca extract. As described in greater detail in the examples, the use of Yucca extract in a composition including hydrogen peroxide and citric acid eradicated algae in a short period of time, typically within a day. In fact, algae treated with this composition started to change color within 30 minutes. It is believed that the unique characteristics of saponins, especially Yucca extract, help to adhere the oxidizing agent and optional stabilizer to the applied areas of the water or soil, thereby preventing dispersion and maximizing effectiveness of the composition. Furthermore, the addition of Yucca extract surprisingly provided longer algae free periods than without the Yucca extract.

### D. Water

Water constitutes the remainder of the composition. Deionized water is preferable. However, water from natural sources including mineral cations may also be used, depending on the desired characteristic of the product.

### E. Other Useful Ingredients

The compositions of the present invention can include additional useful ingredients. It is preferred to limit the concentration of these ingredients to less than or equal to about 15% by weight of the composition.

The compositions of the present invention can also include any ingredient known to the skilled artisan for treating algae and pests in water or soil, clarifying water, and disinfecting water. Useful ingredients are typically known in the art as disinfectants, germicides, biocides, bactericides, algicides, fungicides, clarifiers, insecticides, or pesticides.

Suitable algicides can be found in U.S. Pat. No. 6,149,821 to Rounds et al., U.S. Pat. No. 5,783,091 to Werle et al., which are all incorporated herein by reference. Suitable disinfectants can also be found in Block et al., “Disinfection, Sterilization and Preservation,” 4^{th} Ed. (1991 Lea & Febiger, Pennsylvania), which is incorporated herein by reference in its entirety. Suitable insecticides can be found in U.S. Pat. No. 5,998,475 to James et al., which is incorporated herein by reference in its entirety.

The compositions of the present invention can also include surfactants. Suitable examples of surfactants can be found in U.S. Pat. No. 5,523,012 to Winterton et al. and U.S. Pat. No. 6,803,057 to Ramirez et al., which are incorporated herein by reference it their entirety.

### Manufacturing Process

The composition can be made using any process known to the skilled artisan. For example, the composition can be made by adding the components in any order or by separating the components by groups. Furthermore, the components can be segregated into two or more separate composition portions (e.g., separate containers) and then combined to make the composition. This is typically done to prevent premature release of oxygen from the oxidizing agent. Examples of two or more composition portions as are follows: (1) one portion including the oxidizing agent and water, and a second portion including the thickener, stabilizer, and water; and (2) one portion including the oxidizing agent, stabilizer and water, and a second portion including thickener and water. Alternatively, each component can be separately added to the water or soil.

As is well known in the art, the oxidizing agent is typically commercially available as an aqueous solution, typically in concentrations of 35 wt % or 50 wt %. Water is typically added first and then the active components. The thickener is typically added last.

### Method of Use

The compositions of the present invention can be applied to the water or soil using any application method or process known to the skilled artisan. For example, high volumes may be applied by hydraulic spraying, and low volumes may be applied by manual pump spraying. The compositions may also be injected into the water or soil.

It is, however, preferable to selectively apply the compositions using automatic or manual spray emitters or sprayers to specific portions of the water or soil. For example, the composition can be selectively applied to problem areas of water features and large water bodies, such as the borders, edges, structural and ornamental features. These areas or structures typically have greater growth of algae and slime. Other structural features that can benefit from selective application include, but are not limited to, waterfalls, bridges, rocks, abutments, islands, filters, pumps, pipes, skimmers and drains. This application technique can also be used to treat water features after draining the water.

Without wanting to be limited by any one theory, it is believed that selective application has the benefit of limiting peak concentrations of the oxidizing composition to a local area for short periods of time, thereby preventing exposure of the entire ecosystem or body of water to potentially harmful concentrations of the oxidizing agent. As a result, selective application can, for example, be used to treat algae, while protecting desirable flora (e.g., ornament but sensitive water plants) and fauna (e.g., fish, reptiles, or amphibians) without requiring removal. Furthermore, when the oxidizing agent is capable of producing oxygen as a byproduct, such as hydrogen peroxide, the increased levels of oxygen help to sustain a healthy environment for aerobic life forms, such as fauna. Selective application also minimizes costs, since a smaller amount of the composition needs to be used.

The present invention also includes a method of applying the compositions described previously to the surface of the water and skimming the debris from the water. In this method, the composition can be applied over the entire surface of the water and algae, but is preferably applied the selective portions of the water surface (e.g., on the algae and immediate vicinity around the algae). When the oxidizing agent is capable of producing a gas as a byproduct (e.g., hydrogen peroxide produces oxygen gas), it is believed that the gas bubbles associate with the debris from the algae, thereby increasing buoyancy of the debris. This floating debris can then be removed by a garden hose. Any known method or apparatus known in the art can be used to remove the floating debris.

In an alternative embodiment, the debris can be dispersed into smaller particulate matter. For example, a medium to high pressure water hose can be used to disperse the debris. Alternative, a mechanical agitation apparatus can be used to disperse the debris.

As discussed above, the present invention is directed a method of treating algae, fungi, and slime bacteria by applying the compositions described herein.

The present invention also includes methods of using the compositions described herein to treat water or soil having insects and other pests. An unexpected result of the field trials was the lethal effect it had upon insects and pests that were present in the water feature or large body of water. The insects and pests that can be adversely affected by the compositions described herein include, but are not limited to, mosquitoes, flies, nematodes, mealy bug, aphids, spider mites, white fly, thrip, and combinations thereof. It is believed that the oxidizing agent adversely affects the embryonic stages of the insects and pests. The treatment is highly effective, because of the short lifetime of most insects and pests and the vulnerability of insects in the embryonic stages the treatment is highly effective. Accordingly, the compositions of the present invention would be especially desirable for use in rice fields, which have a combination of algae, insect, and pest problems.

### EXAMPLES

Examples of the invention are set forth hereinafter by way of illustration and are not intended to be in any way limiting of the invention, as many variations thereof are possible without departing from the spirit and scope of the invention.

### Example 1

### Treatment of a Golf Course Water Hazard for Algae and Flies

A golf course water hazard in Northern California contained large mats (i.e., growths) of string algae during the summer months. The algae were predominantly confined to the edges of the water body. Previous treatment methods included use of copper sulfate, which also killed most of the flora and fauna in the water feature. Furthermore, a special permit is needed to apply toxic copper sulfate.

A manual spray pump applicator was used to apply a stabilized hydrogen peroxide solution to water features. The an aqueous solution include 35% by weight of hydrogen peroxide, 10% by weight of citric acid, and 1.85% by weight of Yucca Extract. The aqueous solution was selectively applied to the edges of the golf course water hazard containing large mats of string algae, i.e., the water and pond bank immediately surrounding the mats. After approximately 1 hour, the bulk of the algal mat turned white and broke loose and was made buoyant. It is believed that the oxidative action of the hydrogen peroxide killed the algal mat, and that the resulting debris was made buoyant by association with the oxygen byproducts. Other portions of the algal mat disintegrated and automatically dispersed. The floating debris was then manually skimmed with a net.

The golf course water hazard also had flies. About two days after the treatment, virtually no flies could be found.

### Example 2

### Treatment of a Drained Pond

A badly fouled pond containing string algae and bacterial slime was drained. The damp watercourses and equipment were then treated with an aqueous composition including 10% by weight of hydrogen peroxide, 14.8% by weight of citric acid, and 1.8% by weight Yucca extract. After 2 hrs, the pond and watercourses were refilled with fresh water, and the rocks were hosed with a stream of water to speed the removal of the treated algae. Upon filling, a buoyant surface scum formed that was supported by oxygen bubbles. The scum was comprised of dead algae and other detritus, which was manually skimmed by nets. Immediately after skimming, the water was clear and able to support one dozen large Koi fish without any ill effects. Upon running of the pumps and the waterfalls, more floating algae debris appeared. This material was skimmed and thus removed by the pond systems built-in automatic skimmer.

### Example 3

### Treatment of a Granite Fountain

In an alternative embodiment, filamentous algae covered a granite boulder fountain in Cannel, Calif. The water was turned off, and the boulder was directly treated with a aqueous solution including 7% by weight of hydrogen peroxide, 14% by weight of citric acid, 2% by weight of ascorbic acid, and 5% by weight of yucca extract. A manual pump sprayer was used for application. After about 1 hour, oxygen bubbles swelled and lifted large portions of the algal mat. The water pump was then restarted and large portions of the algal mat were sloughed off. The decomposed mat was then manually removed from the bottom of the fountain boulder.

### Example 4

### Treatment of a Waterfall

In an alternative embodiment, an algae fouled pondless waterfall containing watercourses and a shallow 1,893 L (500 gallon) collection basin was turned off and treated by spray application with 1 quart of an aqueous composition including 7% by weight hydrogen peroxide, 1% by weight citric acid, 0.5% by weight ascorbic acid, and 1.8% by weight of Yucca extract. After 1 hour, the waterfall was turned back on, and the algae, slime, and scum were sloughed off by the action of the waterfall. The buoyant algal mat collected in the basin at the foot of the waterfall and was subsequently removed by skimming.

Although the process, composition and methods of the present invention have been described with reference to specific exemplary embodiments, it will be evident to those of ordinary skill in this art that various modifications and changes may be made to these embodiments without departing from the scope of the invention as set forth in the claims. Accordingly, the specification is to be regarded as illustrative and not restrictive.

1: (canceled)

2: (canceled)

3: (canceled)

4: (canceled)

5: (Canceled)

6: (canceled)

7: (canceled)

8: (canceled)

9: process of making a composition for treating algae or pests, the process comprising,
a first step of adding a stabilizer to an aqueous solution comprising an oxidizing agent; and
a second step of adding a thickener to the mixture of the first step.

10: (canceled)

11: (canceled)

12: (canceled)

13: (canceled)

14: (canceled)

15: (canceled)

16: (canceled)

17: (canceled)

18: (canceled)

19: (canceled)

20: (canceled)

21: (canceled)

22: (canceled)

23: (canceled)

24: (canceled)

25: (canceled)

26: (canceled)

27: (canceled)

28: (canceled)

29: (canceled)

30: A method of treating algae on a surface selected from the group consisting of a surface of a body of water and a solid surface, said method comprising applying a solution to said algae on said surface said solution comprising hydrogen peroxide, citric acid and saponin in water.

31: A method as in claim 30 in which the concentration of said hydrogen peroxide is from about 0.1% by weight to 50% by weight, said citric acid has a concentration efficient to stabilize said hydrogen peroxide when mixed with said water and saponin and said saponin has a concentration effective to increase the time for which said solution remains effective to impede the growth of said algae.

32: A method as in claim 30 in which said citric acid has a concentration of from about 0.1% to about 40% by weight, and said saponin has a concentration of from about 0.001% to about 25% by weight.

33: A method as in claim 30 in which said solution is a sprayable liquid, and said applying step comprises spraying said solution on said algae.

34: A method as in claim 33 in which said algae is located in a limited area in the periphery of a body of water, and said solution is sprayed only in said limited area.

35: A method as in claim 33 in which said surface is on turf.

36: A method as in claim 33 in which said surface is a portion of a waterway, and said solution is sprayed on the algae in said waterway portion.

37: A method as in claim 30 including forming said solution by the preliminary steps including providing first and second parts, each in a separate container, one of said parts containing said hydrogen peroxide, and the other part containing said saponin and said citric acid, and combining a quantity of each of said first and second parts together.

38: A method as in claim 37 including the further preliminary step of adding water to the quantities of said first and second parts to make said solution.

39: A method as in claim 37 in which said first part comprises hydrogen peroxide with de-ionized water.

40: A method of making an algaecide/insecticide, said method comprising
(a) providing a first liquid part in a first container, said first liquid part containing water and hydrogen peroxide, and
(b) providing a second liquid part in a second container, said second part comprising a stabilizer, water and saponin, and
(c) distributing said first and second parts to users for their mixing of said first and second parts together and application of the resulting solution to algae on water or solid surfaces.

41: A method as in claim 40 in which said water in at least said first part is deionized water, and said stabilizer is citric acid.

42: A method as in claim 40 in which the concentrations of hydrogen peroxide, stabilizer and saponin in said liquid parts are substantially higher than in said solution, and including the step of directing said users to add water to said parts before use.

43: A method as in claim 40 in which said solution is a free-flowing, sprayable liquid.

44: A method as in claim 40 including directing said users as to mixing said parts together and applying said solution to selected areas near said algae.

45: A method as in claim 40 in which said stabilizer is citric acid and the concentration of said hydrogen peroxide in said first part is from about 10% to about 25% by weight, and said saponin has a concentration in said second part of from about 1% to about 10% by weight.
